(19) United States
(12) Patent Application Publication
(10) Pub. No.: US 2019/0117501 A1
(43) Pub. Date: Apr. 25, 2019

(54) CHEST COMPRESSION DEVICE WITH PLUNGER ADJUSTING PATIENT CONTACT SITE DURING COMPRESSIONS

(71) Applicant: PHYSIO-CONTROL, INC., Redmond, WA (US)

(72) Inventors: FRED WILLIAM CHAPMAN, NEWCASTLE, WA (US); ERIK VON SCHENCK, LOMMA (SE); ANDERS NILSSON, AKARP (SE); SARA LINDROTH, LUND (SE); THOMAS FALK, STAFFANSTORP (SE); GREGORY T. KAVOUNAS, BELLEVUE, WA (US)

(21) Appl. No.: 16/157,943

(22) Filed: Oct. 11, 2018

Related U.S. Application Data
(60) Provisional application No. 62/571,210, filed on Oct. 11, 2017.

(51) Int. Cl. A61H 31/00; A61H 23/00

(52) U.S. Cl. CPC A61H 31/006; A61H 31/005; A61H 23/006; A61H 2230/208; A61H 2230/255; A61H 2205/084; A61H 2230/405; A61H 2031/001; A61H 2201/1621; A61H 2201/0196; A61H 2201/5025; A61H 2230/305

(57) ABSTRACT

A Cardio-Pulmonary Resuscitation (“CPR”) device can include a compression mechanism configured to perform successive CPR compressions on a chest of a patient, the compression mechanism including a piston and a contact member attached to the piston, the contact member configured to make and maintain contact with the chest at a first position and a first orientation. The CPR device can also include a controller communicatively coupled with the compression mechanism, the controller configured to: receive at least one input; determine whether the piston should be adjusted based on the at least one input; and responsive to a determination that the piston should be adjusted, cause the piston to move so that the contact member makes and maintains contact with the chest at a second position and a second orientation.

### CROSS REFERENCE TO RELATED PATENT APPLICATIONS

This patent application claims the benefit of U.S. Provisional Patent Application Ser. No. 62/571,210, filed on Oct. 11, 2017, the disclosure of which is hereby incorporated by reference for all purposes.

### BACKGROUND

In certain types of medical emergencies a patient's heart stops working. This stops the blood flow, without which the patient may die. Cardio Pulmonary Resuscitation (CPR) can forestall the risk of death. CPR includes performing repeated chest compressions to the chest of the patient so as to cause their blood to circulate some. CPR also includes delivering rescue breaths to the patient. CPR is intended to merely maintain the patient until a more definite therapy is made available, such as defibrillation. Defibrillation is an electrical shock deliberately delivered to a person in the hope of correcting their heart rhythm.

Guidelines by medical experts such as the American Heart Association provide parameters for CPR to cause the blood to circulate effectively. The parameters are for aspects such as the frequency of the compressions, the depth that they should reach, and the full release that is to follow each of them. The depth is sometimes required to exceed 5 cm (2 in.). The parameters also include instructions for the rescue breaths.

Traditionally, CPR has been performed manually. A number of people have been trained in CPR, including some who are not in the medical professions just in case. However, manual CPR might be ineffective, and being ineffective it may lead to irreversible damage to the patient's vital organs, such as the brain and the heart. The rescuer at the moment might not be able to recall their training, especially under the stress of the moment. And even the best trained rescuer can become quickly fatigued from performing chest compressions, at which point their performance might be degraded. Indeed, chest compressions that are not frequent enough, not deep enough, or not followed by a full decompression may fail to maintain blood circulation.

The risk of ineffective chest compressions has been addressed with CPR chest compression machines. Such machines have been known by a number of names, for example CPR chest compression machines, mechanical CPR devices, cardiac compressors and so on.

CPR chest compression machines repeatedly compress and release the chest of the patient. Such machines can be programmed so that they will automatically compress and release at the recommended rate or frequency, and can reach a specific depth within the recommended range. Some of these machines can even exert force upwards during decompressions. Sometimes the feature can even pull the chest higher than it would be while at rest—a feature that is called active decompression.

The repeated chest compressions of CPR are actually compressions alternating with releases. They cause the blood to circulate some, which can prevent damage to organs like the brain. For making this blood circulation effective, guidelines by medical experts such as the American Heart Association dictate suggested parameters for chest compressions, such as the frequency, the depth reached, fully releasing after a compression, and so on. The releases are also called decompressions.

At present, most CPR chest compression machines repeat the same type of compressions over and over, pressing each time at the same location of the patient chest. This precise consistency is non-physiologic and may miss an opportunity to better move blood through each part of the patient's circulatory systems.

Some CPR chest compression machines compress the chest by a piston. Some may even have a suction cup at the end of the piston, with which they lift the chest at least during the releases. This lifting may actively assist the chest in decompressing faster than the chest would accomplish by itself. This type of lifting is sometimes called active decompression.

There remain challenges. Sometimes, due to the repeated and forceful compressions, the body's position may shift within the CPR chest compression machine, in which case the compressions may become less effective. The body's shifting, seen from the perspective of the body, can be characterized as the CPR machine shifting, or a piston migrating or walking, etc.

Mechanical CPR machines today either press with a piston-based solution or a belt-driven solution on the chest during a cardiac arrest to revitalize the patient with the help of a suction cup, hard plate, or belt. Many of these solutions work fine if the device is placed correctly in the middle of the chest of the patient and the patient has the heart placed somewhat to the left of the chest. But, if placed poorly, the devices do not press the heart as they should to get the right compressions during the cardiac arrest.

Mechanical chest compression devices can be challenging to put on the patient, and getting the piston or plunger to be positioned at the intended point on the chest is not easy. Once the device is applied, if the initial positioning was not correct, readjusting its position while the weight of a large patient presses down on the back plate is not easy. Furthermore, the chest compression device can creep in one direction or another during operation, moving it to a suboptimal position and thus requiring adjustment. Also, it is likely that the optimal position for a chest compression device is different from one patient to another.

All of these are situations where a change in plunger/piston position on the chest could be helpful, but there is currently no easy way to accomplish this change in compressions without pausing compressions and repositioning the device. Pausing compressions interrupts precious blood flow, so avoiding these pauses would be beneficial.

### BRIEF SUMMARY

The present description gives instances of CPR chest compression machines, software and methods, the use of which may help overcome problems and limitations of the prior art.

In embodiments a CPR chest compression machine includes a retention structure that is configured to retain a body of the patient, and a compression mechanism. The compression mechanism is coupled to the retention structure and configured to perform successive compressions to the patient's chest. Various types of chest compressions may be performed on a patient during a single resuscitation event.

Some embodiments also include a driver configured to drive the compression mechanism. The compression mechanism may thus perform chest compressions that differ from each other in a number of aspects, for example the depth of the compressions or the height of the active decompressions between the compressions.

Some embodiments also include an adjustment mechanism. The adjustment mechanism may shift the compression mechanism with respect to the patient so that the chest compressions are performed at different locations of the patient's chest.

An advantage over the prior art can be improved blood flow and thus improved CPR patient outcomes. For example, blood flow may be optimized for one side of the patient's heart, then the other.

These and other features and advantages of this description will become more readily apparent from the Detailed Description, which proceeds with reference to the associated drawings in which:

### BRIEF DESCRIPTION OF THE DRAWINGS

FIG. 1 is a diagram of components of an abstracted CPR chest compression machine according to embodiments.

FIG. 2A is a diagram of components of an abstracted CPR chest compression machine that has a contact member making contact with the chest of a patient at a first position and a first orientation according to embodiments.

FIG. 2B is a diagram of the components of FIG. 2A in which the contact member is making contact with the chest of the patient at a second position and a second orientation according to embodiments.

FIG. 2C is a diagram of the components of FIGS. 2A-2B in which the contact member is making contact with the chest of the patient at a third position and a third orientation according to embodiments.

FIG. 2D is a diagram of the components of FIGS. 2A-2C in which the contact member is making contact with the chest of the patient at a fourth position and a fourth orientation according to embodiments.

FIG. 3A is a diagram of components of an abstracted CPR chest compression machine that has a contact member making contact with the chest of a patient at a first position and a first orientation according to embodiments.

FIG. 3B is a diagram of the components of FIG. 3A in which the contact member is making contact with the chest of the patient at a second position and a second orientation according to embodiments.

FIG. 3C is a diagram of the components of FIGS. 3A-3B in which the contact member is making contact with the chest of the patient at a third position and a third orientation according to embodiments.

FIG. 3D is a diagram of the components of FIGS. 3A-3C in which the contact member is making contact with the chest of the patient at a fourth position and a fourth orientation according to embodiments.

FIG. 4A is a diagram of components of an abstracted CPR chest compression machine that has a contact member making contact with the chest of a patient at a first position and a first orientation according to embodiments.

FIG. 4B is a diagram of the components of FIG. 4A in which the contact member is making contact with the chest of the patient at a second position and a second orientation according to embodiments.

FIG. 4C is a diagram of the components of FIGS. 4A-4B in which the contact member is making contact with the chest of the patient at a third position and a third orientation according to embodiments.

FIG. 4D is a diagram of the components of FIGS. 4A-4C in which the contact member is making contact with the chest of the patient at a fourth position and a fourth orientation according to embodiments.

FIG. 5A is a diagram of a first view of a CPR chest compression machine having a retention structure and a contact member for performing chest compressions on a patient according to embodiments.

FIG. 5B is a diagram of a second view of the CPR chest compression machine and patient of FIG. 5A according to embodiments.

FIG. 5C is a diagram of a third view of the CPR chest compression machine and patient of FIGS. 5A-5B according to embodiments.

FIG. 5D is a diagram of the components of FIGS. 5A-5C in which the contact member of the CPR chest compression machine is making contact with the chest of the patient at a first position and a first orientation according to embodiments.

FIG. 5E is a diagram of the components of FIGS. 5A-5D in which the contact member of the CPR chest compression machine is making contact with the chest of the patient at a second position and a second orientation according to embodiments.

FIG. 6 is a flowchart illustrating methods according to embodiments.

### DETAILED DESCRIPTION

As has been mentioned, the present description is about CPR chest compression machines, methods and software that can perform automatically a series of Cardio-Pulmonary Resuscitation (“CPR”) chest compressions on a patient. Embodiments are now described in more detail.

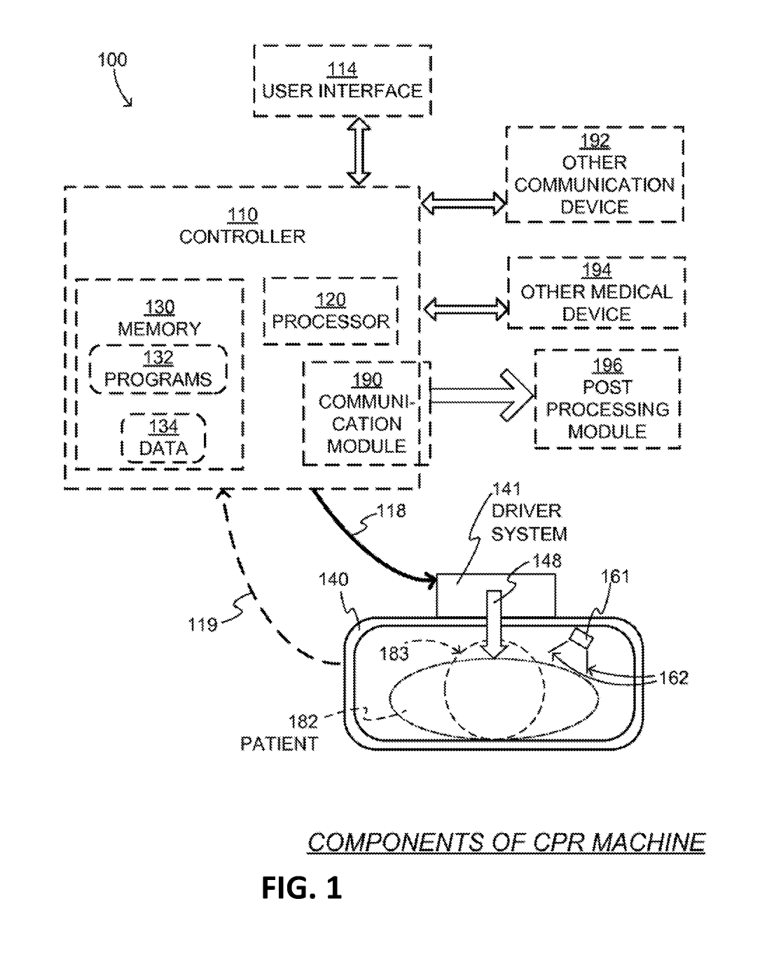

FIG. 1 is a diagram of components 100 of an abstracted CPR chest compression machine according to embodiments. Components 100 include an abstracted retention structure 140 of a CPR chest compression machine. A patient 182 is placed within retention structure 140. Retention structure 140 retains the patient's body, and may be implemented in any number of ways. Good embodiments are disclosed in U.S. Pat. No. 7,569,021 to Jolife AB which is incorporated by reference; these embodiments and are being sold by Physio-Control, Inc. under the trademark LUCAS®. In other embodiments retention structure 140 includes a belt that can be placed around the patient's chest. While retention structure 140 typically reaches the chest and the back of patient 182, it does not reach the head 183.

Components 100 also include a compression mechanism 148 configured to perform successive compressions to a chest of the patient, and a driver 141 configured to drive compression mechanism 148 so as to cause compression mechanism 148 to perform successive compressions to the patient's chest. Compression mechanism 148 and driver 141 may be implemented in combination with retention structure 140 in any number of ways. In the above mentioned example of U.S. Pat. No. 7,569,021 compression mechanism 148 includes a piston, and driver 141 includes a rack-and-pinion mechanism. In embodiments where retention structure 140 includes a belt, compression mechanism 148 may include a spool for collecting and releasing the belt so as to squeeze and release the patient's chest, and driver 141 can include a motor for driving the spool.

Driver 141 may be controlled by a controller 110 according to embodiments. Controller 110 may be coupled with a User Interface 114, for receiving user instructions, and for outputting data.

Controller 110 may include a processor 120. Processor 120 can be implemented in any number of ways, such as with a microprocessor, Application Specific Integration Circuits (ASICs), programmable logic circuits, general processors, etc. While a specific use is described for processor 120, it will be understood that processor 120 can either be standalone for this specific use, or also perform other acts.

In some embodiments controller 110 additionally includes a memory 130 coupled with processor 120. Memory 130 can be implemented by one or more memory chips. Memory 130 can be a non-transitory storage medium that stores instructions 132 in the form of programs. Instructions 132 can be configured to be read by processor 120, and executed upon reading. Executing is performed by physical manipulations of physical quantities, and may result in functions, processes, actions and/or methods to be performed, and/or processor 120 to cause other devices or components to perform such functions, processes, actions and/or methods. Often, for the sake of convenience only, it is preferred to implement and describe a program as various interconnected distinct software modules or features, individually and collectively also known as software. This is not necessary, however, and there may be cases where modules are equivalently aggregated into a single program, even with unclear boundaries. In some instances, software is combined with hardware in a mix called firmware.

While one or more specific uses are described for memory 130, it will be understood that memory 130 can further hold additional data, such as event data, patient data, and so on. For example, data gathered according to embodiments could be aggregated in a database over a period of months or years and used to search for evidence that one pattern or another of CPR is consistently better (in terms of a measured parameter) than the others, of course correlating with the patient. If so, this could be used to adapt the devices to use that pattern either continuously or at least as one of their operating modes.

Controller 110 can be configured to control driver 141 according to embodiments. Controlling is indicated by arrow 118, and can be implemented by wired or wireless signals and so on. Accordingly, compressions can be performed on the chest of patient 182 as controlled by controller 110. In embodiments, the compressions are performed automatically in one or more series, and perhaps with pauses between them as described below, as controlled by controller 110. A single resuscitation event can be a single series of compressions for the same patient, or a number of series thus performed sequentially.

Controller 110 may be implemented together with retention structure 140, in a single CPR chest compression machine. In such embodiments, arrow 118 is internal to such a CPR chest compression machine. Alternately, controller 110 may be hosted by a different machine, which communicates with the CPR chest compression machine that uses retention structure 140. Such communication can be wired or wireless. The different machine can be any kind of device, such as a medical device. One such example is described in U.S. Pat. No. 7,308,304, titled “COOPERATING DEFIBRILLATORS AND EXTERNAL CHEST COMPRESSION MACHINES”, only the description of which is incorporated by reference. Similarly, User Interface 114 may be implemented on the CPR chest compression machine, or on a host device.

Certain implementations may include a chest compression device that has a piston with which it compresses the patient chest. The piston may contact the patient chest at a contact site, which can be adjusted, e.g., re-aimed to contact a different site in the patient, during the chest compressions with little or no pausing of the compressions, e.g., with as little disruption to the chest compressions as possible. The adjustment may be responsive to one or more sensed patient parameters, one or more inputs by the operator of the device or medical professional, or a combination thereof.

The adjustment mechanism may be used in a number of different scenarios. For example, if, after applying the device, it becomes apparent that the plunger/piston did not get in the right position, chest compressions could be started anyway and the position could adjusted right away during compressions. In situations where the device was positioned correctly but has crept away from that position over time, e.g., after a few minutes, the positioning could be corrected quickly and easily during ongoing compressions.

In situations where the device appears to be positioned correctly but the physiological signals indicate poor blood flow during ongoing compressions, position of the plunger could be adjusted slowly while watching for the physiological signals to improve. The signals could include maximal (or end tidal) airway CO2 partial pressure, or amplitude of the pulse oximeter photoplethysmography waveform, or cerebral oximetry measure, or arterial blood pressure, or an ultrasound-based measurement of blood flow through the aorta or carotid arteries. This would facilitate a search for the best plunger positioning.

Whereas previous techniques included repeatedly moving the point of compression around to different sites on the patient's chest, e.g., cycling through a series of sites to provide different types of CPR at different moments, embodiments of the disclosed technology may allow the operator of the device to adjust the site of the compressions in a very controlled way, e.g., so that they can get it to be “just right” in terms of either a site that they see visually would be better than the current site or a site that provides better physiological results, for example.

In certain embodiments where the chest compressor includes a suction cup or other mechanism for attaching to the chest, the CPR device may cause the suction cup to briefly release from the chest as the operator moves the site of the compression on the chest. For example, a feature may break the suction for one or more compression cycles, e.g., by opening a valve to let air escape into the suction cup. The valve could either be part of the disposable plunger with a control connection to the main body of the device, or the valve could be part of the piston assembly and have an opening into the inside of the suction cup, e.g., via the pressure pad. For devices with other mechanisms of attaching to the chest, e.g., Velcro, a feature may undo the attachment temporarily.

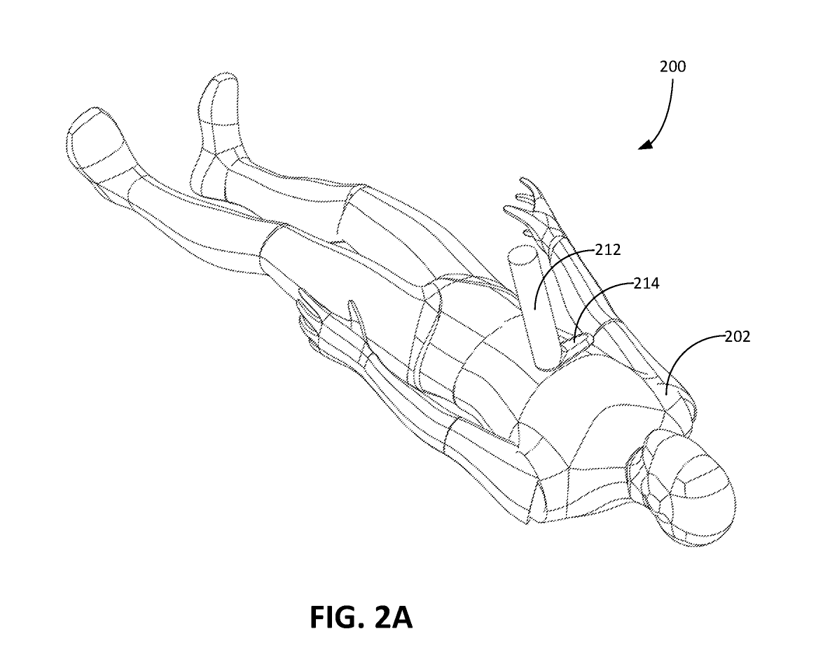

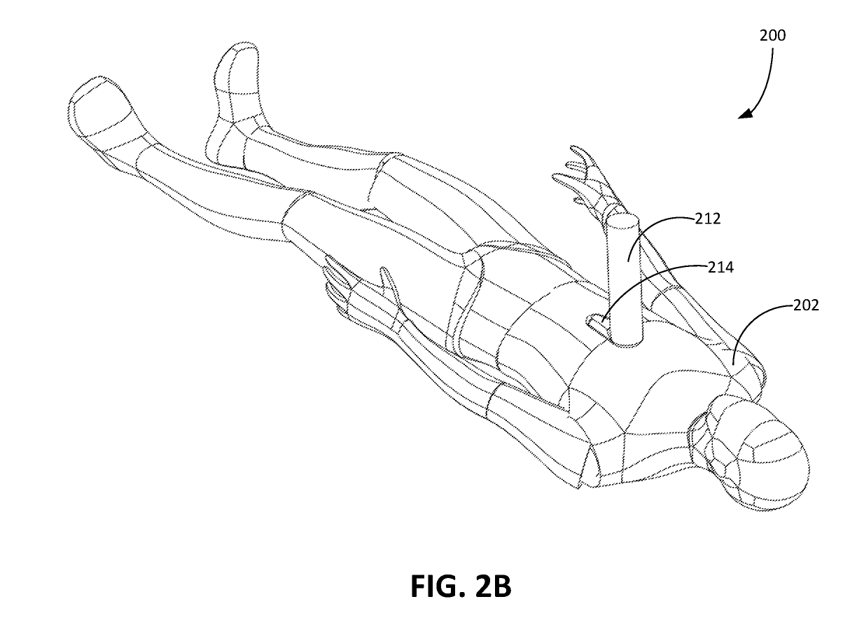

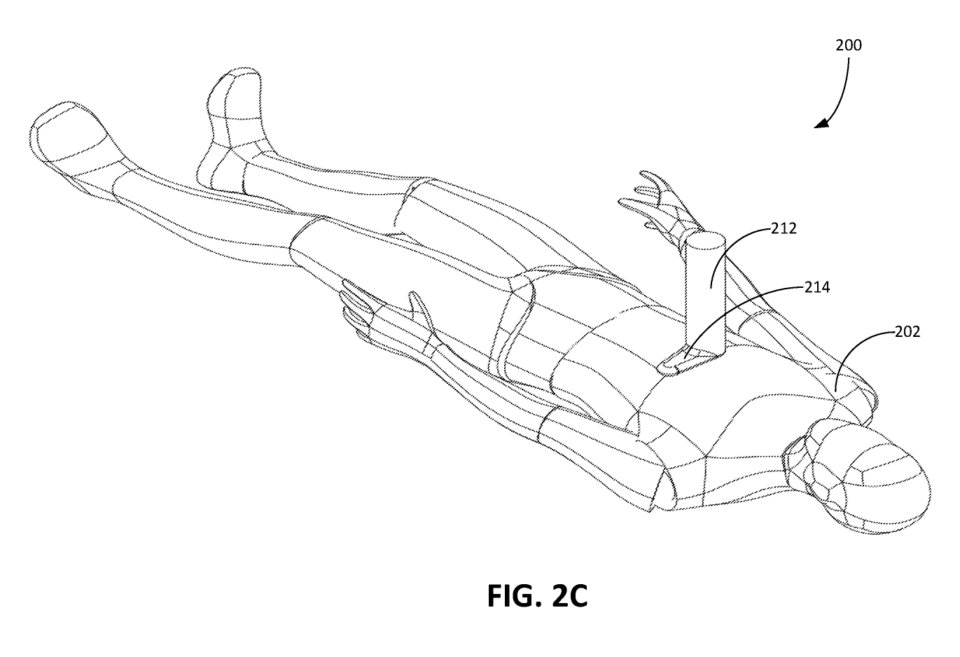

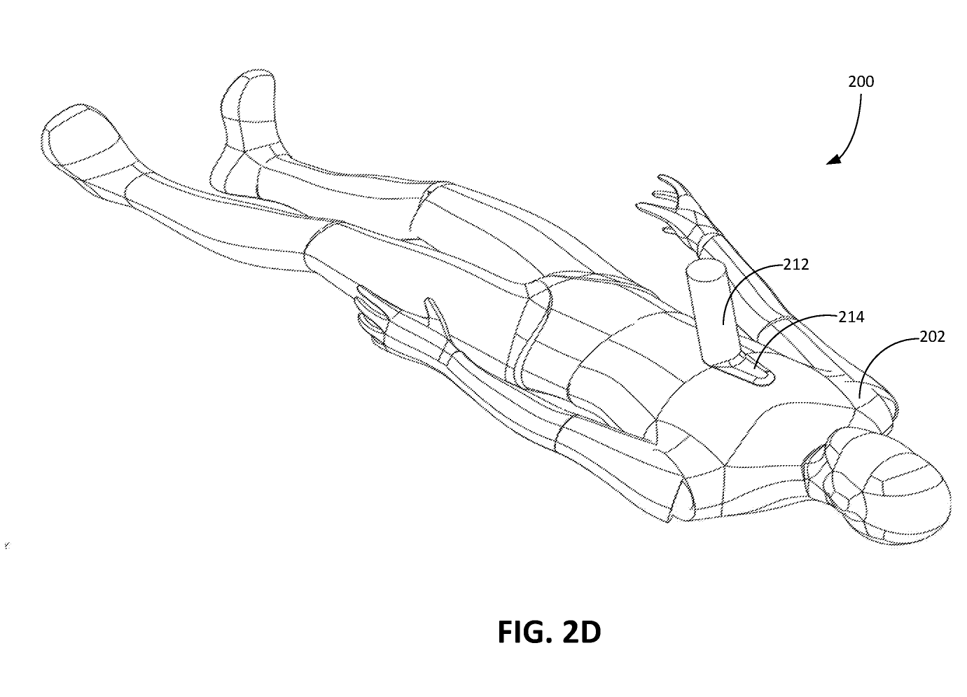

FIG. 2A is a diagram of components 200 of an abstracted CPR chest compression machine that has a contact member 214 making contact with the chest of a patient 202 at a first position and a first orientation according to embodiments. In the example, the CPR chest compression machine includes a compression mechanism having a piston 212, and the contact member 214 is attached to the piston 212. In certain embodiments, the contact member 214 is removably attached to the piston 212, e.g., for easy attachment thereto before the chest compressions and easy removal therefrom after delivery of the chest compressions. In FIG. 2A, the contact member 214 is positioned and oriented generally so as to face toward the patient's right arm.

FIG. 2B is a diagram of the components 200 of FIG. 2A in which the contact member 214 is making contact with the chest of the patient 202 at a second position and a second orientation according to embodiments. Here, the contact member 214 has been moved, e.g., rotated by the piston 212, such that it is positioned and oriented generally so as to face toward the patient's feet. In certain embodiments, the movement of the piston 212 and thus the contact member 214 may be responsive to a determination that the piston 212 should be adjusted, e.g., based on an input received by the CPR chest compression machine. The input may be an input provided by a user or an input that includes at least one physiological parameter, e.g., as determined by the CPR device.

FIG. 2C is a diagram of the components 200 of FIGS. 2A-2B in which the contact member is making contact with the chest of the patient 202 at a third position and a third orientation according to embodiments. Here, the contact member 214 has been moved, e.g., rotated by the piston 212, such that it is positioned and oriented generally so as to face toward the patient's left arm. In certain embodiments, the movement of the piston 212 and thus the contact member 214 may be responsive to a determination that the piston 212 should be adjusted again, e.g., based on another input received by the CPR chest compression machine. The additional input may be an input provided by a user or an input that includes at least one physiological parameter, e.g., as determined by the CPR device.

FIG. 2D is a diagram of the components 200 of FIGS. 2A-2C in which the contact member is making contact with the chest of the patient 202 at a fourth position and a fourth orientation according to embodiments. Here, the contact member 214 has been moved, e.g., rotated by the piston 212, such that it is positioned and oriented generally so as to face toward the patient's head. In certain embodiments, the movement of the piston 212 and thus the contact member 214 may be responsive to a determination that the piston 212 should be adjusted yet again, e.g., based on yet another input received by the CPR chest compression machine. As with the first and second inputs, this input may be an input provided by a user or an input that includes at least one physiological parameter, e.g., as determined by the CPR device.

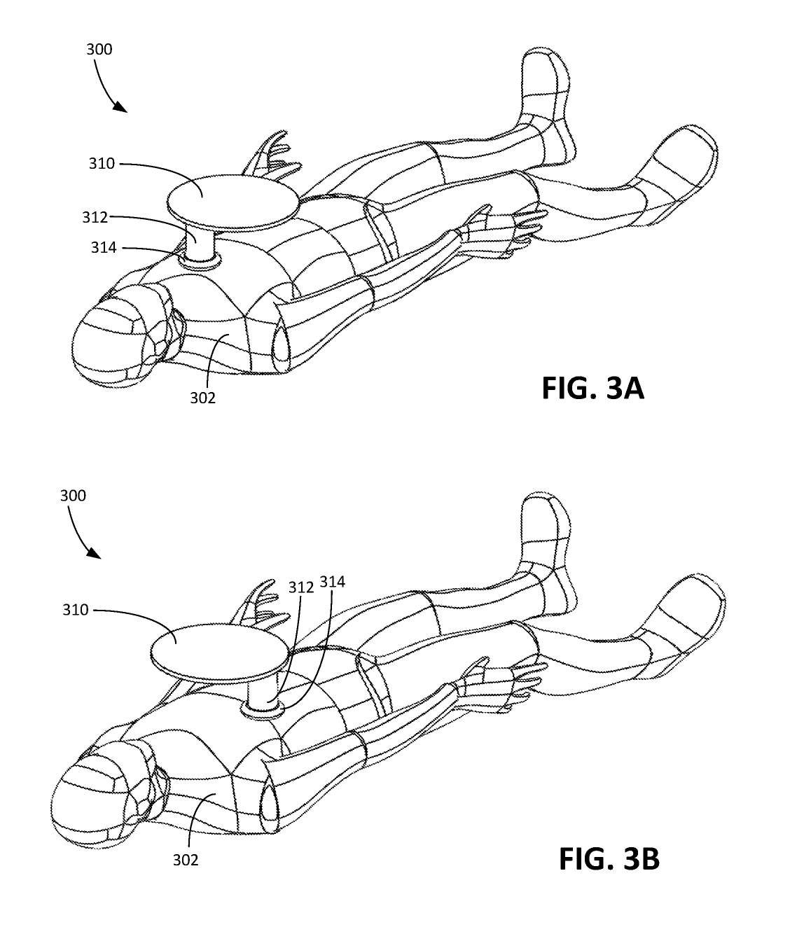

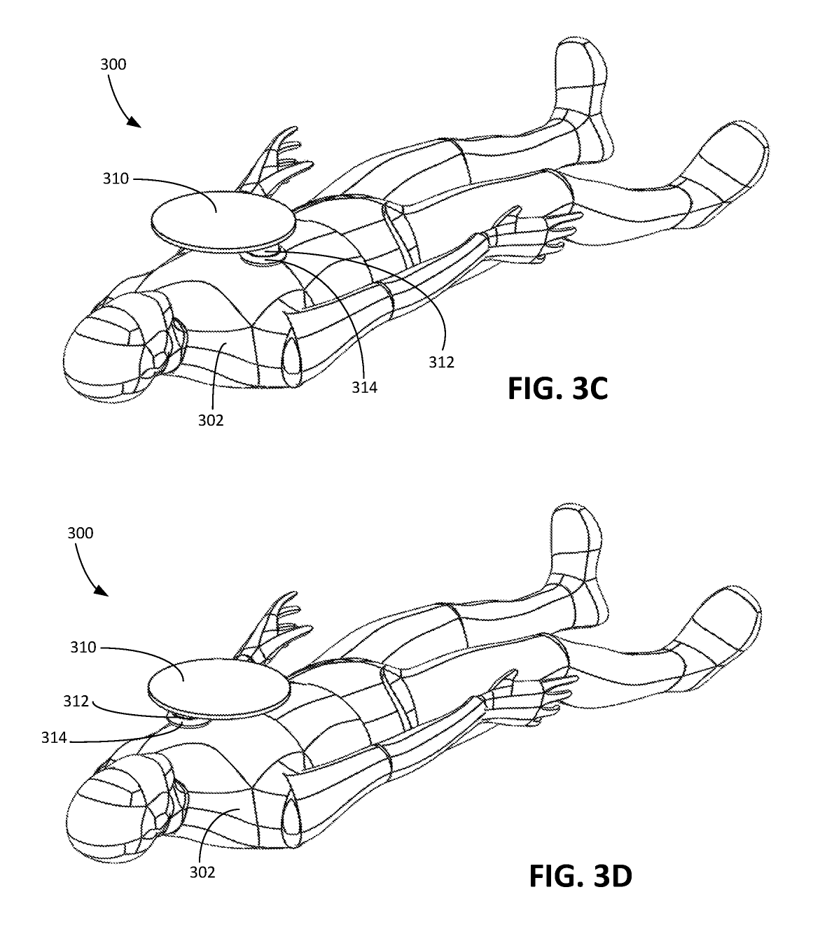

FIG. 3A is a diagram of components 300 of an abstracted CPR chest compression machine that has a contact member 314 making contact with the chest of a patient 302 at a first position and a first orientation according to embodiments. In the example, the CPR chest compression machine includes a compression mechanism having a disk-shaped component 310 and a piston 312, and the contact member 314 is attached to the piston 312. In certain embodiments, the contact member 314 is removably attached to the piston 312, e.g., for easy attachment thereto before the chest compressions and easy removal therefrom after delivery of the chest compressions. In FIG. 3A, the contact member 314 is positioned and oriented generally toward the patient's head.

FIG. 3B is a diagram of the components 300 of FIG. 3A in which the contact member 314 is making contact with the chest of the patient 302 at a second position and a second orientation according to embodiments. Here, the contact member 314 has been moved, e.g., by the disk-shaped component 310 and piston 312, such that it is positioned and oriented generally toward the patient's right arm. In certain embodiments, the movement of the disk-shaped component 310 and piston 312 and thus the contact member 314 may be responsive to a determination that the assembly should be adjusted, e.g., based on an input received by the CPR chest compression machine. The input may be an input provided by a user or an input that includes at least one physiological parameter, e.g., as determined by the CPR device.

FIG. 3C is a diagram of the components 300 of FIGS. 3A-3B in which the contact member is making contact with the chest of the patient 302 at a third position and a third orientation according to embodiments. Here, the contact member 314 has been moved, e.g., by the disk-shaped component 310 and piston 312, such that it is positioned and oriented generally toward the patient's feet. In certain embodiments, the movement of the disk-shaped component 310 and piston 312 and thus the contact member 314 may be responsive to a determination that the assembly should be adjusted, e.g., based on another input received by the CPR chest compression machine. The additional input may be an input provided by a user or an input that includes at least one physiological parameter, e.g., as determined by the CPR device.

FIG. 3D is a diagram of the components 300 of FIGS. 3A-3C in which the contact member is making contact with the chest of the patient 302 at a fourth position and a fourth orientation according to embodiments. Here, the contact member 314 has been moved, e.g., by the disk-shaped component 310 and piston 312, such that it is positioned and oriented generally toward the patient's left arm. In certain embodiments, the movement of the disk-shaped component 312 and thus the contact member 314 may be responsive to a determination that the assembly should be adjusted, e.g., based on yet another input received by the CPR chest compression machine. As with the first and second inputs, this input may be an input provided by a user or an input that includes at least one physiological parameter, e.g., as determined by the CPR device.

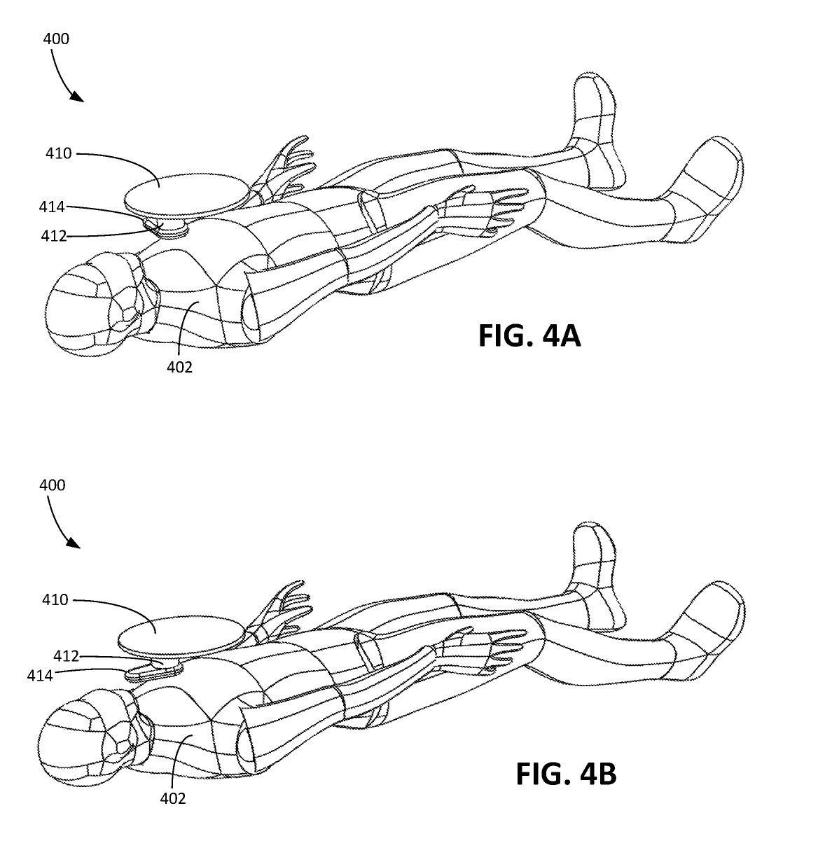

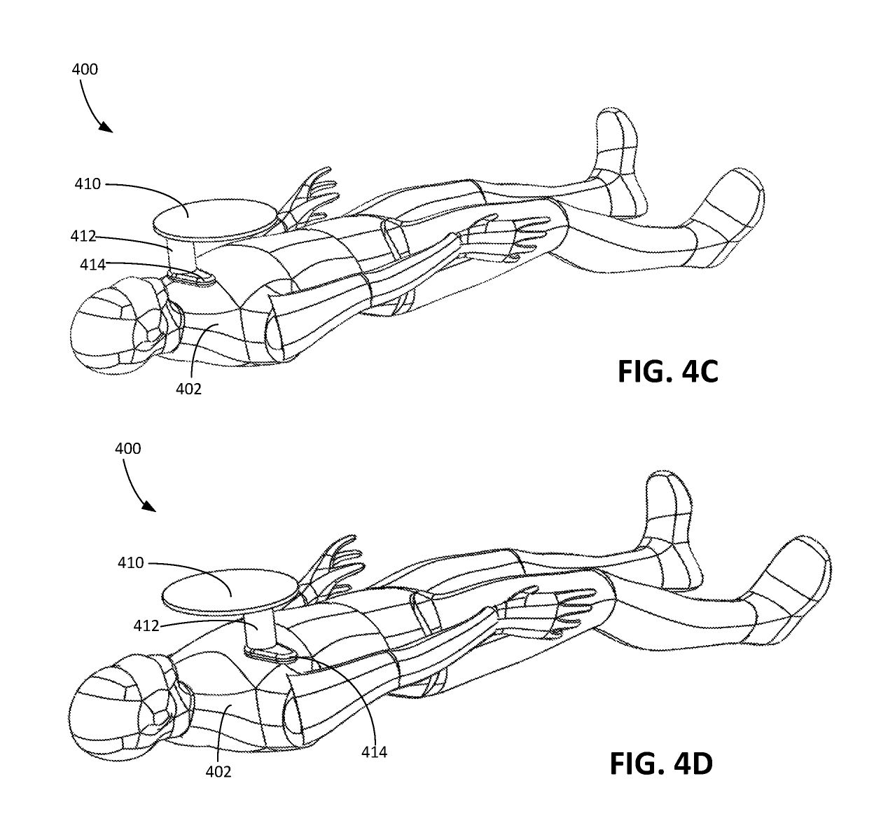

FIG. 4A is a diagram of components of an abstracted CPR chest compression machine that has a contact member making contact with the chest of a patient 402 at a first position and a first orientation according to embodiments. In the example, the CPR chest compression machine includes a compression mechanism having a disk-shaped component 410 and a piston 412, and the contact member 414 is attached to the piston 412. In certain embodiments, the contact member 414 is removably attached to the piston 412, e.g., for easy attachment thereto before the chest compressions and easy removal therefrom after delivery of the chest compressions. In FIG. 4A, the contact member 414 is positioned generally toward the patient's left arm and oriented generally toward the patient's feet.

FIG. 4B is a diagram of the components of FIG. 4A in which the contact member is making contact with the chest of the patient 402 at a second position and a second orientation according to embodiments. Here, the contact member 414 has been moved, e.g., by the piston 412, such that its position is generally unchanged and it is oriented generally toward the patient's head. In certain embodiments, the movement of the disk-shaped component 410 and piston 412 and thus the contact member 414 may be responsive to a determination that the assembly should be adjusted, e.g., based on an input received by the CPR chest compression machine. The input may be an input provided by a user or an input that includes at least one physiological parameter, e.g., as determined by the CPR device.

FIG. 4C is a diagram of the components of FIGS. 4A-4B in which the contact member is making contact with the chest of the patient 402 at a third position and a third orientation according to embodiments. Here, the contact member 414 has been moved, e.g., by the disk-shaped component 410 and piston 412, such that it is positioned generally toward the patient's head and oriented generally toward the patient's right arm. In certain embodiments, the movement of the disk-shaped component 410 and piston 412 and thus the contact member 414 may be responsive to a determination that the assembly should be adjusted, e.g., based on another input received by the CPR chest compression machine. The additional input may be an input provided by a user or an input that includes at least one physiological parameter, e.g., as determined by the CPR device.

FIG. 4D is a diagram of the components of FIGS. 4A-4C in which the contact member is making contact with the chest of the patient 402 at a fourth position and a fourth orientation according to embodiments. Here, the contact member 414 has been moved, e.g., by the disk-shaped component 410 and piston 412, such that it is positioned and oriented generally toward the patient's right arm. In certain embodiments, the movement of the disk-shaped component 410 and piston 412 and thus the contact member 414 may be responsive to a determination that the assembly should be adjusted, e.g., based on another input received by the CPR chest compression machine. The additional input may be an input provided by a user or an input that includes at least one physiological parameter, e.g., as determined by the CPR device.

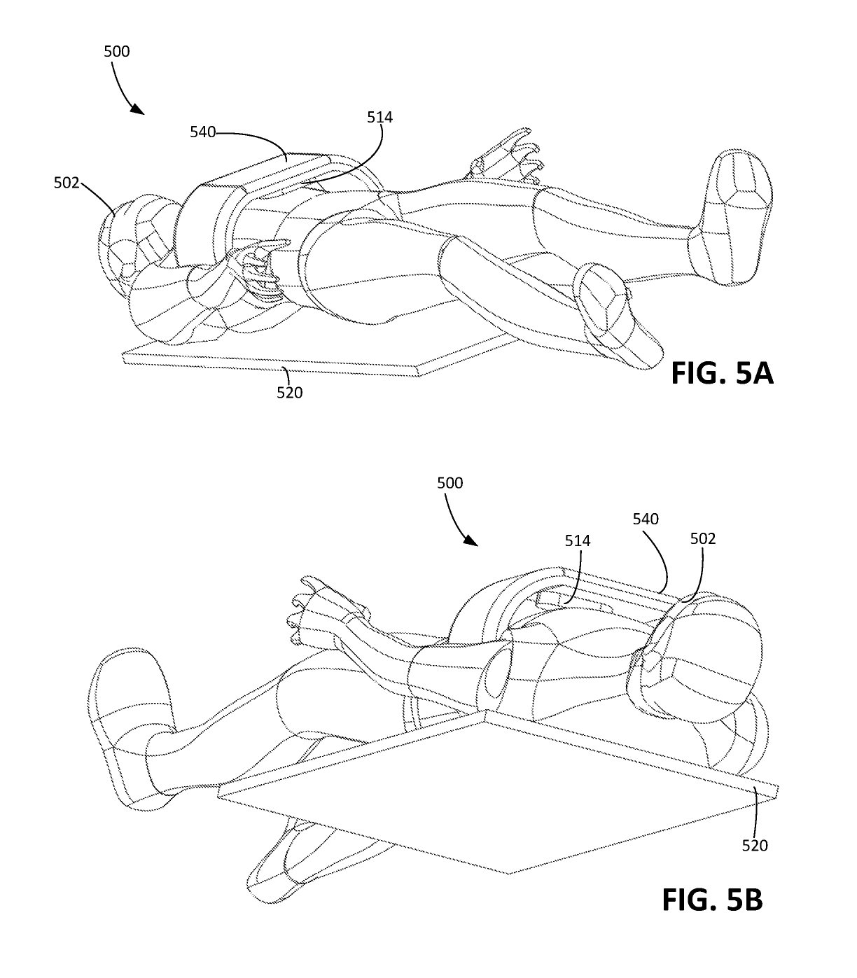

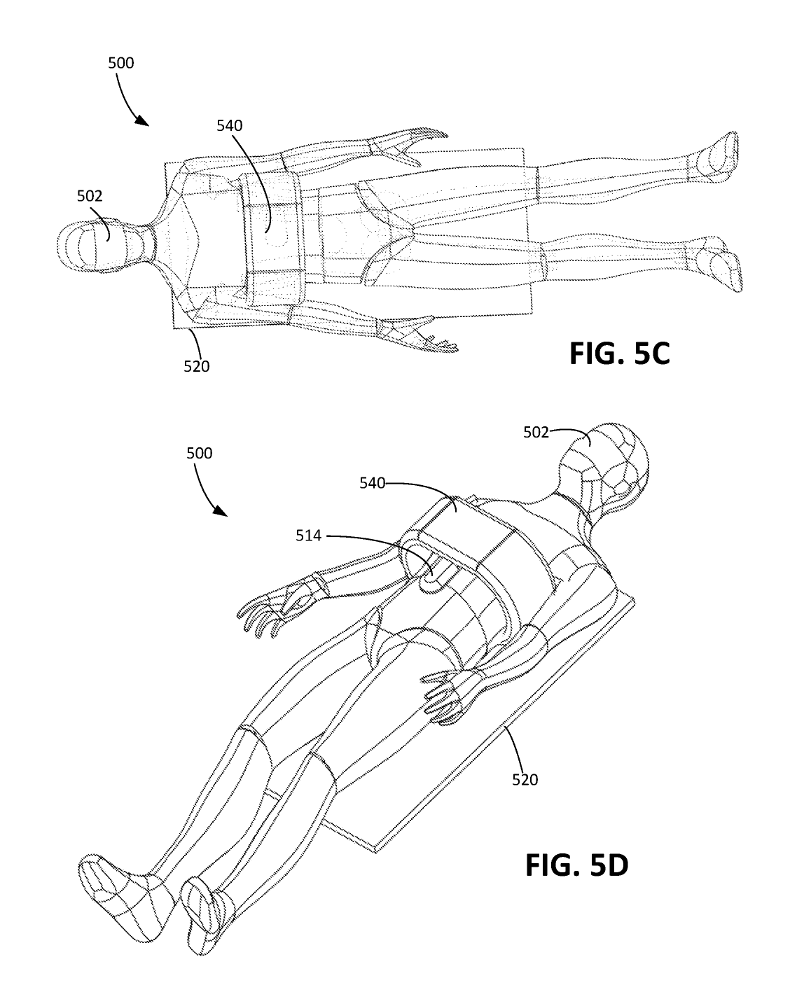

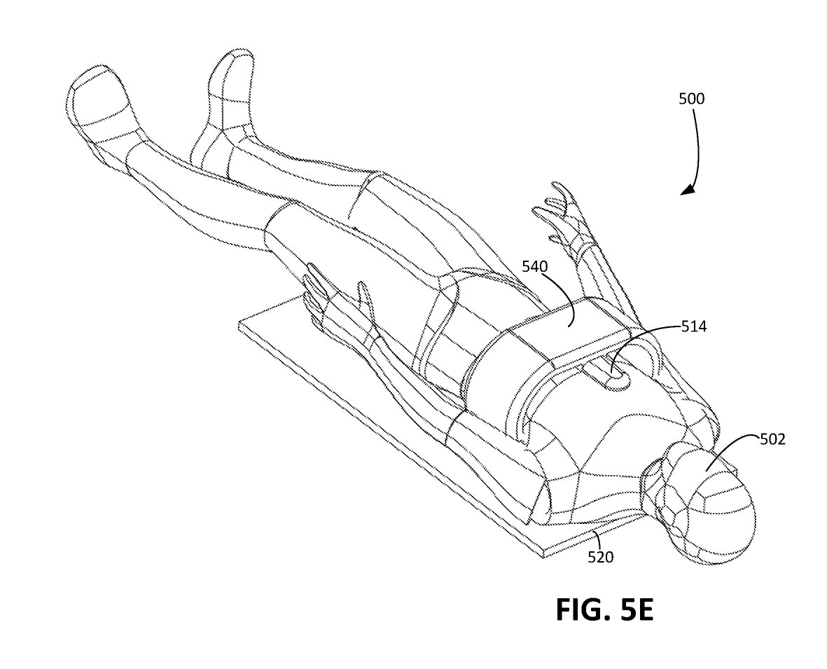

FIG. 5A is a diagram of a first view of components 500 of a CPR chest compression machine for performing chest compressions on a patient 502 according to embodiments. In the example, the CPR chest compression machine includes a retention structure 540 and a base 520 for securing the patient 502. A contact member 514 may be used to deliver the chest compressions to the patient 502.

FIG. 5B is a diagram of a second view of the components 500 of FIG. 5A according to embodiments.

FIG. 5C is a diagram of a third view of the components 500 of FIGS. 5A-5B according to embodiments.

FIG. 5D is a diagram of the components 500 of FIGS. 5A-5C in which the contact member 514 of the CPR chest compression machine is making contact with the chest of the patient 502 at a first position and a first orientation generally toward the patient's feet according to embodiments.

FIG. 5E is a diagram of the components 500 of FIGS. 5A-5D in which the contact member 514 of the CPR chest compression machine is making contact with the chest of the patient 502 at a second position and a second orientation generally toward the patient's head according to embodiments.

The devices and/or systems made according to embodiments perform functions, processes and/or methods, as described in this document. These functions, processes and/or methods may be implemented by one or more devices that include logic circuitry, such as was described for controller 110.

Moreover, methods and algorithms are described below. This detailed description also includes flowcharts, display images, algorithms, and symbolic representations of program operations within at least one computer readable medium. An economy is achieved in that a single set of flowcharts is used to describe both programs, and also methods. So, while flowcharts describe methods in terms of boxes, they also concurrently describe programs. A method is now described.

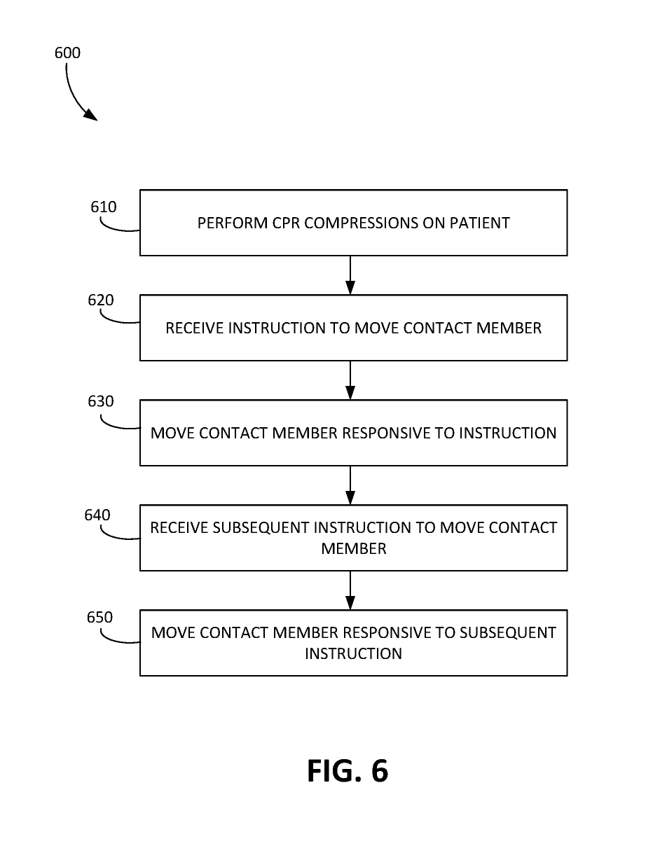

FIG. 6 shows a flowchart 600 for describing methods according to embodiments. The methods of flowchart 600 may also be practiced by embodiments described elsewhere in this document for performing automatically a series of successive compressions to a chest of a patient.

According to an operation 610, a compression mechanism of a CPR device is used to perform successive CPR compressions on a chest of a patient. The compression mechanism may include a piston and a contact member attached to the piston, and the contact member may be configured to make contact with the chest at a first position and a first orientation.

According to another operation 620, the CPR device receives an instruction to move the contact member to a second position and a second orientation. The instruction may include at least one physiological parameter determined by the CPR device, an input provided by a user, or a combination thereof.

According to another operation 630, the CPR device, responsive to receiving the instruction, may cause the piston to move so that the contact member makes contact with the chest at the second position and the second orientation. For example, the CPR device may cause the piston to rotate about an axis that is substantially perpendicular to the chest. In alternative embodiments, the CPR device may cause the contact member to move longitudinally with respect to the chest. It will be appreciated that, in certain embodiments, the first and second positions may be substantially the same, the first and second orientations may be substantially the same, or both.

According to an optional operation 640, the CPR device receives a subsequent instruction to move the contact member to a third position and a third orientation. The instruction may include at least one physiological parameter determined by the CPR device, an input provided by a user, or a combination thereof.

According to an optional operation 650, the CPR device, responsive to receiving the subsequent instruction, may cause the piston to move so that the contact member makes contact with the chest at the third position and the third orientation. For example, the CPR device may cause the piston to rotate about an axis that is substantially perpendicular to the chest. In alternative embodiments, the CPR device may cause the contact member to move longitudinally with respect to the chest. It will be appreciated that, in certain embodiments, the second and third positions may be substantially the same, the second and third orientations may be substantially the same, or both.

In some embodiments the compression mechanism includes a piston coupled to the retention structure, and a contact member coupled to the piston. In these embodiments, the adjustment mechanism may be coupled between the piston and the contact member, and shifting may be performed by shifting the contact member with respect to the piston.

In the methods described above, each operation can be performed as an affirmative step of doing, or causing to happen, what is written that can take place. Such doing or causing to happen can be by the whole system or device, or just one or more components of it. In addition, the order of operations is not constrained to what is shown, and different orders may be possible according to different embodiments. Moreover, in certain embodiments, new operations may be added, or individual operations may be modified or deleted. The added operations can be, for example, from what is mentioned while primarily describing a different system, apparatus, device or method.

Returning to FIG. 1, components 100 can be augmented with a sensor (not shown) for sensing a physiological parameter of patient 182. The physiological parameter can be an Arterial Systolic Blood Pressure (ABSP), a blood oxygen saturation (SpO2), a ventilation measured as End-Tidal CO2 (ETCO2), a temperature, a detected pulse, etc. In addition, this parameter can be what is detected by defibrillator electrodes that may be attached to patient 182, such as ECG and impedance. The sensor can be implemented either on the same device as controller 110 or not, and so on.

Upon sensing the physiological parameter, a value of it can be transmitted to controller 110, as is suggested via arrow 119. Transmission can be wired or wireless.

Controller 110 may further optionally aggregate resuscitation data, for transmission to a post processing module 190. The resuscitation data can include what is learned via arrow 119, time data, etc. Transmission can be performed in many ways, as will be known to a person skilled in the art. In addition, controller 110 can transmit status data of the CPR chest compression machine that includes retention structure 140.

A person skilled in the art will be able to practice the present invention in view of this description, which is to be taken as a whole. Details have been included to provide a thorough understanding. In other instances, well-known aspects have not been described, in order to not obscure unnecessarily the present invention. Plus, any reference to any prior art in this description is not, and should not be taken as, an acknowledgement or any form of suggestion that this prior art forms parts of the common general knowledge in any country.

This description includes one or more examples, but that does not limit how the invention may be practiced. Indeed, examples or embodiments of the invention may be practiced according to what is described, or yet differently, and also in conjunction with other present or future technologies. Other embodiments include combinations and sub-combinations of features described herein, including for example, embodiments that are equivalent to: providing or applying a feature in a different order than in a described embodiment; extracting an individual feature from one embodiment and inserting such feature into another embodiment; removing one or more features from an embodiment; or both removing a feature from an embodiment and adding a feature extracted from another embodiment, while providing the features incorporated in such combinations and sub-combinations.

In this document, the phrases “constructed to” and/or “configured to” denote one or more actual states of construction and/or configuration that is fundamentally tied to physical characteristics of the element or feature preceding these phrases. This element or feature can be implemented in any number of ways, as will be apparent to a person skilled in the art after reviewing the present disclosure, beyond any examples shown in this example.

The following claims define certain combinations and subcombinations of elements, features and steps or operations, which are regarded as novel and non-obvious. Additional claims for other such combinations and subcombinations may be presented in this or a related document. When used in the claims, the phrases “constructed to” and/or “configured to” reach well beyond merely describing an intended use, since such claims actively recite an actual state of construction and/or configuration based upon described and claimed structure.

We claim:

1. A Cardio-Pulmonary Resuscitation (“CPR”) device, comprising:
a compression mechanism configured to perform successive CPR compressions on a chest of a patient, the compression mechanism including a piston and a contact member attached to the piston, the contact member configured to make and maintain contact with the chest at a first position and a first orientation; and
a controller communicatively coupled with the compression mechanism, the controller configured to:
receive at least one input;
determine whether the piston should be adjusted based on the at least one input; and
responsive to a determination that the piston should be adjusted, cause the piston to move so that the contact member makes and maintains contact with the chest at a second position and a second orientation.

2. The CPR device of claim 1, wherein the at least one input includes at least one physiological parameter determined by the CPR device.

3. The CPR device of claim 1, wherein the at least one input is an input provided by a user.

4. The CPR device of claim 1, wherein causing the piston to move includes causing the piston to rotate about an axis that is substantially perpendicular to the chest.

5. The CPR device of claim 4, wherein an angle between the first and second orientations is approximately 90 degrees.

6. The CPR device of claim 1, wherein causing the piston to move includes causing the contact member to move longitudinally with respect to the chest.

7. The CPR device of claim 1, wherein the controller is further configured to:
receive at least one subsequent input;
determine whether the piston should be further adjusted based on the at least one subsequent input; and
responsive to a determination that the piston should be further adjusted, cause the piston to further move so that the contact member makes and maintains contact with the chest at a third position and a third orientation.

8. The CPR device of claim 7, wherein causing the piston to further move includes causing the piston to rotate about an axis that is substantially perpendicular to the chest.

9. The CPR device of claim 8, wherein an angle between the second and third orientations is approximately 90 degrees.

10. The CPR device of claim 7, wherein the first and third orientations are substantially the same.

11. The CPR device of claim 7, wherein causing the piston to further move includes causing the contact member to move longitudinally with respect to the chest.

12. The CPR device of claim 1, wherein the contact member is a suction cup configured to secure a mechanical connection between the piston and the chest.

13. The CPR device of claim 12, wherein causing the piston to move includes instructing the user to release the suction cup from the chest.

14. The CPR device of claim 2, wherein the at least one physiological parameter is selected from the following group: maximal airway CO2 partial pressure, amplitude of pulse oximeter photoplethysmography waveform, cerebral oximetry measure, arterial blood pressure, and an ultrasound-based measurement of blood flow.

15. A Cardio-Pulmonary Resuscitation (“CPR”) device, comprising:
a compression mechanism configured to perform successive CPR compressions on a chest of a patient, the compression mechanism including a piston and a contact member attached to the piston, the contact member configured to make contact with the chest at a first position and a first orientation; and
a controller communicatively coupled with the compression mechanism, the controller configured to:
receive an instruction from a user to move the contact member to a second position and a second orientation; and
responsive to the instruction, cause the piston to rotate so that the contact member makes contact with the chest at the second position and the second orientation.

16. The CPR device of claim 15, wherein an angle between the first and second orientations is approximately 90 degrees.

17. The CPR device of claim 15, wherein the controller is further configured to:
receive a subsequent instruction from the user to move the contact member to a third position and a third orientation; and
responsive to the subsequent instruction, cause the piston to rotate so that the contact member makes and maintains contact with the chest at the third position and the third orientation.

18. The CPR device of claim 17, wherein an angle between the second and third orientations is approximately 90 degrees.

19. The CPR device of claim 15, wherein the contact member is a suction cup configured to secure a mechanical connection between the piston and the chest.

20. A non-transitory computer-readable storage medium storing instructions that, when executed by a processor of a Cardio-Pulmonary Resuscitation (“CPR”) device, cause the CPR device to perform a method comprising:
using a compression mechanism of the CPR device to perform successive CPR compressions on a chest of a patient, the compression mechanism including a piston and a contact member attached to the piston, wherein the contact member is configured to make contact with the chest at a first position and a first orientation;
receiving an instruction to move the contact member to a second position and a second orientation; and
responsive to receiving the instruction, causing the piston to move so that the contact member makes contact with the chest at the second position and the second orientation.
